(19) United States
(12) Patent Application Publication
(10) Pub. No.: US 2013/0070887 A1
(43) Pub. Date: Mar. 21, 2013

(54) REACTOR ADAPTED FOR MITIGATING LOSS-OF-COOLANT ACCIDENT AND MITIGATION METHOD THEREOF

(71) Applicants: Young In Kim, Daejeon (KR); Young Dong Hwang, Daejeon (KR); Young Jong Chung, Daejeon (KR); Won Jae Lee, Gongju Chungcheongnam-Do (KR); Keung Koo Kim, Daejeon (KR); Hwang Bae, Daejeon (KR); Jung Yoon, Daejeon (KR); Sung Kyun Zee, Daejeon (KR); Cheon Tae Park, Daejeon (KR)

(72) Inventors: Young In Kim, Daejeon (KR); Young Dong Hwang, Daejeon (KR); Young Jong Chung, Daejeon (KR); Won Jae Lee, Gongju Chungcheongnam-Do (KR); Keung Koo Kim, Daejeon (KR); Hwang Bae, Daejeon (KR); Jung Yoon, Daejeon (KR); Sung Kyun Zee, Daejeon (KR); Cheon Tae Park, Daejeon (KR)

(73) Assignee: KOREA ATOMIC ENERGY RESEARCH INSTITUTE, Daejeon (KR)

(21) Appl. No.: 13/615,779

(22) Filed: Sep. 14, 2012

(30) Foreign Application Priority Data
Sep. 19, 2011 (KR) 10-2011-0094017

(51) Int. Cl. G21C 9/00

(52) U.S. Cl. 376/282

(57) ABSTRACT

Disclosed are a nuclear reactor adapted for mitigating a loss-of-coolant accident and a mitigation method thereof. The nuclear reactor includes a nuclear reactor vessel, a first pipe part connected to the nuclear reactor vessel to supply or drain fluid, and a first opening/closing part connected to the first pipe part. When the first pipe part is broken, the first opening/closing part closes the first pipe part to stop discharge of coolant. A supplementary coolant injection part is connected to the nuclear reactor vessel through a second pipe part. When the second pipe part is broken, a second opening/closing part closes the second pipe part to stop discharge of coolant.

### CROSS-REFERENCE TO RELATED APPLICATIONS

This application claims the priority of Korean Patent Application No. 10-2011-0094017 filed on Sep. 19, 2011, in the Korean Intellectual Property Office, the disclosure of which is incorporated herein by reference.

### BACKGROUND OF THE INVENTION

1. Field of the Invention

The present invention relates to a nuclear reactor adapted for mitigating a loss-of-coolant accident and a method of mitigating a loss-of-coolant accident, and more particularly, to a nuclear reactor including a pipe connected to a nuclear reactor vessel and opened and closed by a member such as a valve, such that when the pipe is broken, the valve closes the pipe to stop discharge of coolant, thereby mitigating a loss-of-coolant accident, and a method of mitigating a loss-of-coolant accident.

2. Description of the Related Art

In general, a nuclear power plant includes one hundred or more systems having respective functions, the systems being classified into a nuclear steam supply system including a nuclear reactor as a main part, a turbine receiving steam to drive an electricity generator, an electricity generator system, and the other auxiliary apparatuses.

In particular, nuclear reactors which artificially control a fission chain reaction of a nuclear fuel are used for various purposes such as heating, production of radioactive isotopes and plutonium, and the formation of a radiation field.

Of these, pressurized water reactors which use water as a moderator and coolant are classified into loop-type reactors and integral-type reactors, according to the structural features thereof.

A loop-type reactor is separated from a pressurizer, steam generators, and coolant pumps within a nuclear reactor building (a containment vessel), and the pressurizer, the steam generators, and the coolant pumps are also separated from one another, and are connected to one another and the loop-type reactor through large pipes. The steam generator is connected to a steam turbine through a pipe to supply steam for driving an electricity generator, thereby generating electricity.

However, in the case of an integral-type reactor 1 illustrated in FIG. 1, main components constituting a nuclear steam supply system, such as a pressurizer 13, steam generators 14, and nuclear reactor coolant pumps 15, are disposed together with a reactor core 12 within a nuclear reactor vessel 11.

Coolant heated in the reactor core 12 is supplied to the nuclear reactor coolant pumps 15, and is turned downward by the nuclear reactor coolant pumps 15 to an annular cavity at the upper side of the steam generators 14. Then, the coolant is cooled through heat exchange within the steam generators 14, and is then returned to the reactor core 12. This cycle is repeated.

A loss-of-coolant accident (LOCA) is one of the main causes of radiation release accidents at nuclear power plants. When a loss-of-coolant accident occurs, a pressure boundary of a reactor coolant system is broken to cause release of a radioactive material.

As described above, since main components such as the pressurizer 13, the steam generators 14, and the nuclear reactor coolant pumps 15 are disposed within the nuclear reactor vessel 11, the integral-type reactor 1 does not require large pipes for connecting the pressurizer 13, the steam generators 14, and the nuclear reactor coolant pumps 15 to one another. Thus, integral-type reactors can fundamentally prevent a large break loss-of-coolant accident, unlike loop-type reactors.

However, since integral-type reactors still require small pipes for operating safety systems and auxiliary systems, it is difficult to fundamentally prevent a small break loss-of-coolant accident due to the breaking of the small pipes.

Thus, an emergency core cooling system is required to mitigate small break loss-of-coolant accidents.

When a loss-of-coolant accident occurs, a typical loop-type reactor compensates for the loss of coolant through a broken line of a pipe by using an emergency core cooling system that is formed by combining an active system including high and low pressure safety injection pumps, and a passive system including a safety injection tank pressurized with nitrogen gas.

In the initial stage of the loss-of-coolant accident, water is injected into the loop-type reactor from a refueling water tank (RWT) by high and low pressure safety injection pumps, and water pressurized within the safety injection tank is injected into the loop-type reactor.

In the late stage of the loss-of-coolant accident, water is depleted from the refueling water tank and the safety injection tank, and water collected in a sump within a nuclear reactor building (a containment vessel) is injected into the loop-type reactor through the high pressure safety injection pump.

However, since such an emergency core cooling system includes a number of pumps and valves, emergency power for operating the pumps and various devices should be operated for an extended period of time. Thus, the reliability of these devices is degraded, and operations and management of a nuclear reactor are complicated, while economical efficiency thereof is degraded.

Although a valve connected to a pipe closes a broken line of the pipe to mitigate a loss-of-coolant accident, since typical loop-type reactors have large pipes, a coolant loss rate of loop-type reactors is higher than that of integral-type reactors (refer to reference numeral 1). Thus, the level of coolant within loop-type reactors may be quickly decreased.

Hence, there is a limit in mitigating a loss-of-coolant accident by using a valve that closes a broken line of a large pipe of typical loop-type reactors.

When a nuclear reactor uses a safe guard vessel based on the concept of passivity, initial construction costs of the nuclear reactor are increased, and thus, economical efficiency thereof is decreased.

When a nuclear reactor uses an active safety injection system, instead of using a safe guard vessel, much coolant discharges through a broken line of a pipe, and it increases the internal pressure of a nuclear reactor building (a containment vessel). Thus, the nuclear reactor building should be designed to resist the increased internal pressure, and adding of the active safety injection system may increase equipment costs.

That is, to address the loss-of-coolant accident in the related art, a safety injection system may additionally supply coolant to compensate for the loss of coolant through a broken line of the pipe, or a high pressure resistant vessel such as a safe guard vessel may be disposed outside the nuclear reactor vessel to decrease an amount of coolant lost.

Accordingly, equipment costs are increased, and thus, economical efficiency is decreased.

### SUMMARY OF THE INVENTION

An aspect of the present invention provides a nuclear reactor adapted for mitigating a loss-of-coolant accident by using a member such as a valve for quickly closing a broken line of a pipe connected to the nuclear reactor, and a method of mitigating a loss-of-coolant accident.

Another aspect of the present invention provides a nuclear reactor adapted for mitigating a loss-of-coolant accident by using a valve for quickly closing a broken line of a pipe, without using a safety feature required to operate for an extended period of time, such as a safety injection system or a safe guard vessel, thereby decreasing construction costs and improving economical efficiency, and a method of mitigating a loss-of-coolant accident.

Another aspect of the present invention provides a nuclear reactor adapted for mitigating a loss-of-coolant accident by using a valve for quickly closing a broken line of a pipe, thereby decreasing a lost amount of coolant, and it decreases a design pressure of a nuclear reactor building (a containment vessel), thus decreasing construction costs thereof and increasing economical efficiency, and a method of mitigating a loss-of-coolant accident.

Aspects of the present invention are not limited to the previously mentioned embodiments, but other aspects not described herein would be clearly understood by those skilled in the art from descriptions below.

According to an aspect of the present invention, there is provided a nuclear reactor adapted for mitigating a loss-of-coolant accident, including: a nuclear reactor vessel: a first pipe part connected to the nuclear reactor vessel to supply or drain fluid; and a first opening/closing part connected to the first pipe part, wherein when the first pipe part is broken, the first opening/closing part closes the first pipe part to stop discharge of coolant. The first pipe part may be a part of the systems such as a chemical volume control system, a shutdown cooling system, a drain system and so on, and be any pipe part where a loss-of-coolant accident may occur, except for a second pipe part

The nuclear reactor vessel is connected to the first pipe part through a flange to reinforce a connected portion therebetween, and the first opening/closing part may be disposed on the flange.

The nuclear reactor may further include a supplementary coolant injection part (so called “safety injection system”) that is connected to the nuclear reactor vessel to compensate for the loss of coolant through a broken line of the first pipe part. The supplementary coolant injection part may be a safety injection tank storing a high concentration boric acid solution.

The supplementary coolant injection part may be connected to the nuclear reactor vessel through the second pipe part, and a second opening/closing part may be disposed on the second pipe part to close the second pipe part to stop discharge of coolant when the second pipe part is broken.

The nuclear reactor vessel may be connected to the second pipe part through a flange to reinforce a connected portion therebetween, and the second opening/closing part may be disposed on the flange.

The nuclear reactor may further include: a sensor part sensing a loss-of-coolant accident; and a control part controlling opening and closing of the first opening/closing part when the sensor part senses a loss-of-coolant accident.

The nuclear reactor may further include: a sensor part sensing a loss-of-coolant accident; and a control part controlling opening and closing of the second opening/closing part when the sensor part senses a loss-of-coolant accident.

The nuclear reactor may further include an auxiliary power source that supplies power for opening and closing the first opening/closing part when a main power source is disconnected during a loss-of-coolant accident.

The nuclear reactor may further include an auxiliary power source that supplies power for opening and closing the second opening/closing part when a main power source is disconnected during a loss-of-coolant accident.

According to another aspect of the present invention, there is provided a method of mitigating a loss-of-coolant accident in a nuclear reactor, including: sensing a loss-of-coolant accident by a sensor part; and operating, by a control part when a loss-of-coolant accident is sensed, a first opening/closing part to close a first pipe part connected to a side of a nuclear reactor vessel.

The method may further include injecting supplementary coolant from a supplementary coolant injection part into the nuclear reactor vessel when coolant is partially lost.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partial cut-away perspective view illustrating an integral-type nuclear reactor in the related art;

FIG. 2 is a cross-sectional view illustrating a normal operation of a nuclear reactor adapted for mitigating a loss-of-coolant accident according to an embodiment of the present invention;

FIG. 3 is a cross-sectional view illustrating a portion of a nuclear reactor adapted for mitigating a loss-of-coolant accident according to another embodiment of the present invention; and

FIGS. 4 and 5 are cross-sectional views illustrating operations of a nuclear reactor mitigating a loss-of-coolant accident, according to another embodiment of the present invention.

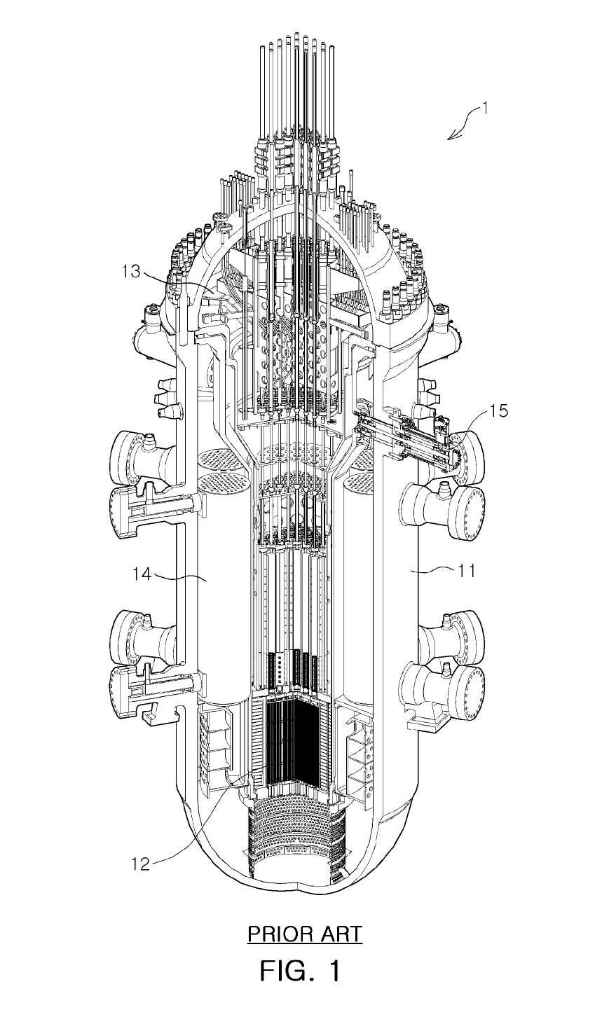

### DETAILED DESCRIPTION OF THE PREFERRED EMBODIMENT

The terms of a singular form may include plural forms unless referred to the contrary. The meaning of “include”, “comprise”, and “have” specifies a property, a region, a fixed number, a step, a process, an element, and/or a component but does not exclude other properties, regions, fixed numbers, steps, processes, elements and/or components.

Hereinafter, a nuclear reactor adapted for mitigating a loss-of-coolant accident and a mitigation method thereof according to embodiments of the present invention will be described with reference to the accompanying drawings.

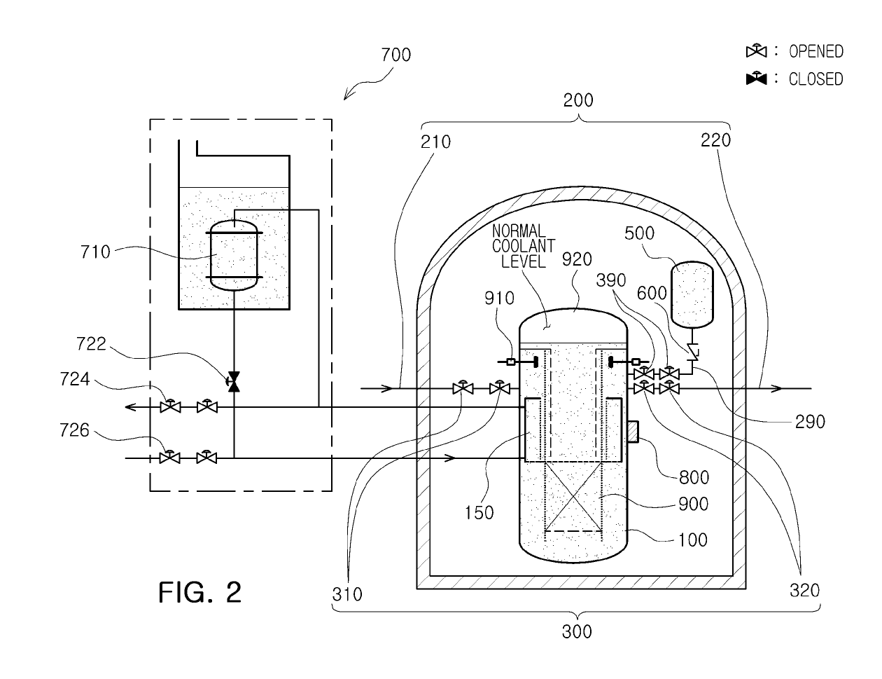

Referring to FIG. 2, a nuclear reactor adapted for mitigating a loss-of-coolant accident according to an embodiment of the present invention includes a nuclear reactor vessel 100.

Further, the nuclear reactor includes first pipe parts 200 connected to the nuclear reactor vessel 100 to supply or drain fluid.

Further, the nuclear reactor includes first opening/closing parts 300 connected to the first pipe parts 200 to close the first pipe parts 200 when the first pipe parts 200 are broken, thereby stopping discharge of coolant.

Although the nuclear reactor is exemplified as an integral-type reactor, the nuclear reactor is not specifically limited. Thus, the nuclear reactor according to the current embodiment may be exemplified as a general reactor that may have a low coolant loss rate as it has small pipes.

The nuclear reactor according to the current embodiment will now be described in detail.

The nuclear reactor according to the current embodiment, as an integral-type nuclear reactor, includes the nuclear reactor vessel 100 in which main components including a reactor core 900, nuclear reactor coolant pumps 910, steam generators 150, and a pressurizer 920 are installed.

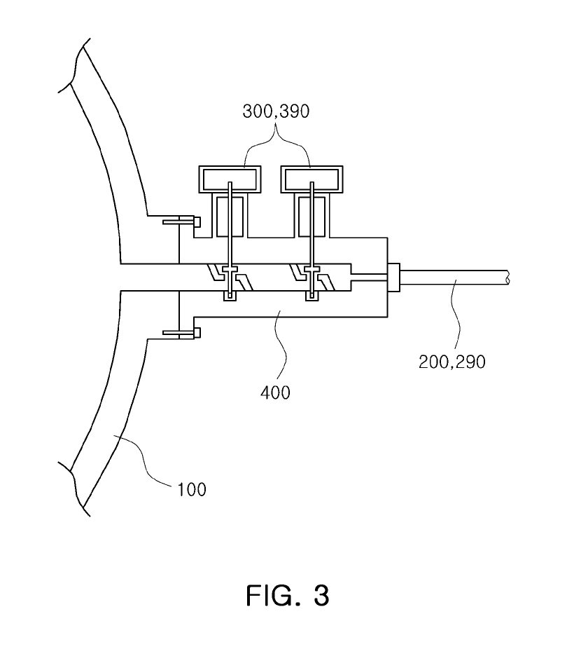

Referring to FIGS. 2 and 3, the nuclear reactor vessel 100 may be connected to the first pipe parts 200 to supply or drain fluid.

For example, in the case of a chemical volume control system, when the level of the coolant within the nuclear reactor vessel 100 falls below an appropriate level, or when a process such as purification of the coolant is needed, the nuclear reactor vessel 100 receives coolant through an inflow pipe 210 of the first pipe parts 200. When the level of the coolant within the nuclear reactor vessel 100 is above an appropriate level, or when a process such as purification of the coolant is needed, the nuclear reactor vessel 100 lets down the coolant through an outflow pipe 220 of the first pipe parts 200.

As such, the quality and level of coolant within the nuclear reactor vessel 100 are adjusted by charging and letting down coolant. In addition, after coolant let down from the outflow pipe 220 is purified, the coolant is returned to the nuclear reactor vessel 100 through the inflow pipe 210.

As illustrated in FIG. 2, the inflow pipe 210 may be connected to a side surface of the nuclear reactor vessel 100, and the outflow pipe 220 may be connected to another side surface of the nuclear reactor vessel 100.

The first pipe part 200 may be provided in plural, so that two or more first pipe parts 200 can be connected to the nuclear reactor vessel 100.

The first opening/closing part 300 may be connected to the first pipe part 200 connected to the nuclear reactor vessel 100. When a portion of the first pipe part 200 is broken, the first opening/closing part 300 closes the first pipe part 200.

That is, since fluid is supplied or drained through the first pipe part 200, the pressure of the coolant may be applied to the first pipe part 200. In addition, external force may be applied to the first pipe part 200.

The pressure of coolant applied to the first pipe part 200, or external force applied to the first pipe part 200 may break the first pipe part 200.

In this case, coolant may be discharged through a broken line of the first pipe part 200, an occurrence known as a loss-of-coolant accident (LOCA).

Accordingly, an amount of coolant within the reactor core 900 is decreased, and heat is not removed from the reactor core 900 and is accumulated therein. As a result, the accumulated heat may melt the reactor core 900, significantly damaging the nuclear reactor.

Moreover, radiation may release from the nuclear reactor vessel 100 through the broken line of the first pipe part 200.

To address these issues, the nuclear reactor includes the first opening/closing parts 300 connected to the first pipe parts 200 to open and close the first pipe parts 200.

That is, even in the case that the first pipe part 200 is broken, the first opening/closing part 300 closes the broken line of the first pipe part 200.

The inflow pipe 210 may be provided with inflow members 310 of the first opening/closing parts 300, and the outflow pipe 220 may be provided with outflow members 320 of the first opening/closing parts 300.

Thus, even in the case that the first pipe part 200 is broken, the broken line of the first pipe part 200 can be closed in an early stage, and a loss-of-coolant accident can be mitigated. Coolant loss is quickly stopped and coolant is supplied, to thereby prevent melting of the reactor core 900, and the nuclear reactor can be shutdown safely.

Since pipes of typical loop-type nuclear reactors are greater than those of integral-type nuclear reactors, when a pipe of a typical loop-type nuclear reactor is broken, coolant is quickly lost through the broken pipe, and the level of the reactor is quickly decreased. Thus, even in the case that a valve closes the broken line of the pipe, a substantial effect cannot be attained.

However, since the nuclear reactor according to the current embodiment (that is, an integral-type nuclear reactor or a general nuclear reactor having no large pipe) has smaller pipes than those of loop-type nuclear reactors, even though a pipe of the nuclear reactor according to the current embodiment may be broken, a coolant loss rate therefrom is lower than that of loop-type nuclear reactors, and a valve effectively closes the broken line, thereby mitigating a loss-of-coolant accident.

In addition, since the nuclear reactor according to the current embodiment, as an integral-type nuclear reactor, has small pipes, a flange 400 (to be described later) and valves used as the first opening/closing parts 300 can be efficiently installed.

The nuclear reactor vessel 100 is connected to the first pipe part 200 through the flange 400 to reinforce a connected portion therebetween.

That is, as illustrated in FIG. 3, the nuclear reactor vessel 100 may be connected to a side of the flange 400, and the first pipe part 200 may be connected to another side of the flange 400.

The flange 400 has strength to resist force capable of breaking the first pipe part 200.

Thus, even in the case that the first pipe part 200 is broken by internal pressure or external force, the flange 400 cannot be broken, so that the first opening/closing part 300 disposed on the flange 400 can be operated. Accordingly, the broken line of the first pipe part 200 is closed.

Even though one first pipe part 200 is connected to the flange 400 in FIG. 3, a plurality of the first pipe parts 200 may be connected to the flange 400.

Referring to FIGS. 2 and 3, the first opening/closing parts 300 are connected to the first pipe parts 200, and close the first pipe parts 200 when the first pipe parts 200 are broken, thereby stopping discharge of coolant.

The first opening/closing parts 300 are disposed on the flange 400 connecting the nuclear reactor vessel 100 to the first pipe part 200.

The first opening/closing parts 300 may be provided as various types of valves for opening and closing the first pipe parts 200.

That is, when the nuclear reactor is operating normally, the reactor may be maintained at an appropriate level of coolant by a chemical and volume control system.

When the first pipe part 200 is broken by an accident, the valves can close the broken line of the first pipe part 200.

One or more valves may be used as one or more first opening/closing parts 300. For example, two valves may be spaced apart from each other by a predetermined distance on the flange 400 as illustrated in FIG. 3.

In this case, when one valve malfunctions, the other valve can operate. Alternatively, three or more valves may be provided on the flange 400, but the application of two valves is economical.

Furthermore, when a plurality of valves are provided, the valves may be different from each other.

When a plurality of valves are provided, at least one of the valves may be operated to mitigate a loss-of-coolant accident.

While one of the valves is operated to mitigate a loss-of-coolant accident, if the valve fails to work, another valve may be operated.

In this case, a sensor may sense whether a working valve is in normal operation, and a control part may control a working valve.

Opening and closing of the first opening/closing parts 300 may be controlled by a control part. That is, when a sensor part senses a loss-of-coolant accident, the control part may control the first opening/closing parts 300 to be closed.

Accordingly, a process of mitigating the loss-of-coolant accident is quickly performed to minimize a coolant loss rate.

Referring to FIGS. 2, 4, and 5, a supplementary coolant injection part (so called “safety injection system”) 500 is connected to the nuclear reactor vessel 100 to compensate for the loss of coolant due to breaking of the first pipe part 200.

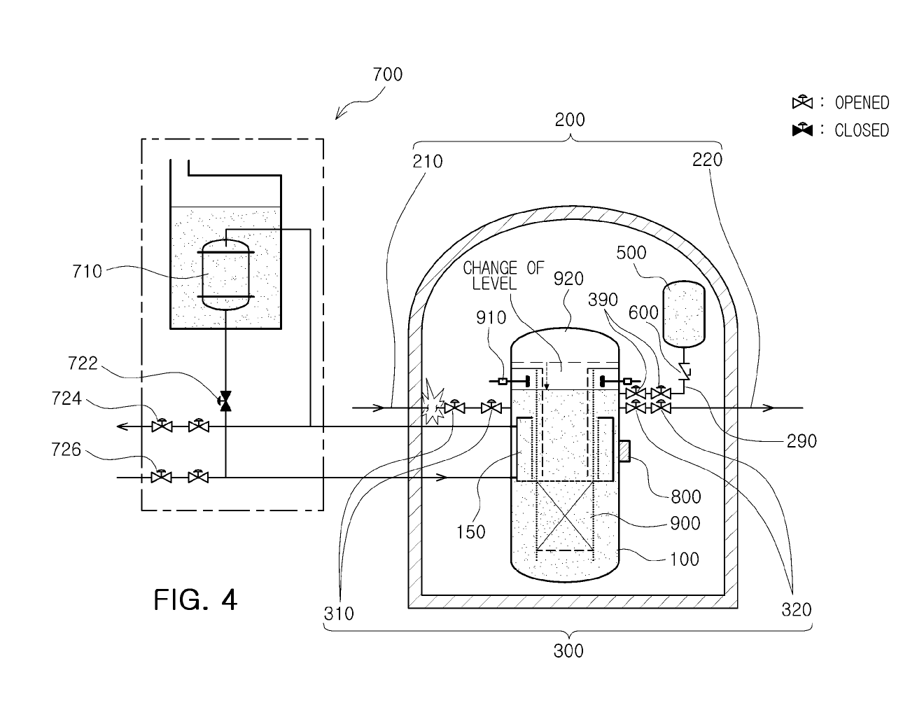

That is, when the first pipe part 200 is broken, a portion of coolant may be discharged through a broken line of the first pipe part 200 before the first opening/closing part 300 closes the first pipe part 200. Accordingly, referring to FIG. 4, the level of the coolant may be lower than a normal state level of the coolant (please refer to FIG. 2).

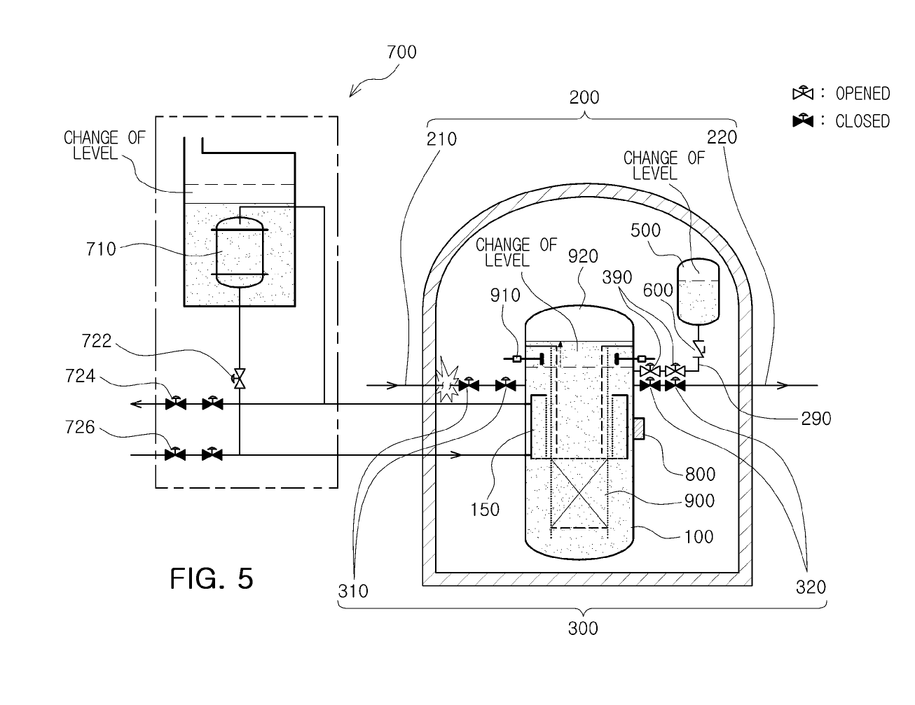

At this point, the nuclear reactor may be shut down according to a nuclear reactor shut down process. In addition, when injection of coolant is needed, the supplementary coolant injection part 500 may inject coolant to compensate for the loss of the coolant, as illustrated in FIG. 5.

The supplementary coolant injection part 500 may be filled with a high concentration boric acid solution as a supplementary coolant, and may be maintained under high pressure by means of nitrogen gas.

Thus, when a portion of coolant loss through a broken line of the first pipe part 200, a difference in pressure may occur between the nuclear reactor vessel 100 and the supplementary coolant injection part 500, thereby injecting the supplementary coolant from the supplementary coolant injection part 500 into the nuclear reactor vessel 100.

The supplementary coolant injection part 500 may be connected to a check valve 600. In a normal state, the check valve 600 is closed by means of a predetermined pressure difference in order to prevent a back flow of coolant from the nuclear reactor vessel 100 to the supplementary coolant injection part 500.

That is, internal pressure of the nuclear reactor vessel 100 is higher than internal pressure of the supplementary coolant injection part 500 in the normal state, thus preventing an introduction of the supplementary coolant from the supplementary coolant injection part 500 into the nuclear reactor vessel 100.

However, when coolant is discharged through a broken line of the first pipe part 200, the internal pressure of the nuclear reactor vessel 100 is decreased to allow the supplementary coolant to flow into the nuclear reactor vessel 100 through the check valve 600 from the supplementary coolant injection part 500 maintained under high pressure by means of nitrogen gas.

That is, the supplementary coolant flows in only one direction from the supplementary coolant injection part 500 to the nuclear reactor vessel 100.

As a result, the supplementary coolant injection part 500 may be connected to the check valve 600, and the supplementary coolant may be injected into the nuclear reactor vessel 100 according to an operation of the check valve 600.

The supplementary coolant injection part 500 may be connected to a second pipe part 290. Second opening/closing parts 390 may be connected to the second pipe part 290 to close the second pipe part 290 when the second pipe part 290 is broken, thereby stopping discharge of coolant.

That is, the second pipe part 290 may connect the nuclear reactor vessel 100 to the supplementary coolant injection part 500, and may be accidentally broken.

When the second pipe part 290 is broken like the first pipe part 200, a loss-of-coolant accident may occur. To mitigate such a loss-of-coolant accident, the second opening/closing parts 390 may be connected to the second pipe part 290.

Like the first opening/closing parts 300, the second opening/closing parts 390 may be connected to a control part. When a sensor part senses a loss-of-coolant accident, the control part may control the second opening/closing parts 390 to be closed.

The supplementary coolant injection part 500 may be provided in plural. In this case, one of the additional supplementary coolant injection parts 500 is used to cope with breaking of the second pipe part 290 connecting the nuclear reactor vessel 100 to the supplementary coolant injection part 500.

That is, when the second pipe part 290 connecting the nuclear reactor vessel 100 to the supplementary coolant injection part 500 is broken, the second opening/closing parts 390 close a broken line of the second pipe part 290.

In this case, since the supplementary coolant injection part 500 connected to the broken second pipe part 290 cannot be used, another supplementary coolant injection part 500 can inject supplementary coolant into the nuclear reactor vessel 100.

The number of supplementary coolant injection parts 500 may be two, and preferably, three or more for emergency use.

An operation of the second opening/closing parts 390 is the same as the operation of the first opening/closing parts 300, and thus, a description of the operation of the second opening/closing parts 390 is referred to in the above description of the operation of the first opening/closing parts 300.

Like the first pipe part 200, the second pipe part 290 may be connected to the nuclear reactor vessel 100 through the flange 400 to reinforce a connected portion therebetween.

That is, the nuclear reactor vessel 100 may be connected to the first side of the flange 400, and the second pipe part 290 connected to the supplementary coolant injection part 500 may be connected to the second side of the flange 400.

The second opening/closing part 390 may be disposed on the flange 400. As in the description of the first opening/closing parts 300, even in the case that the second pipe part 290 is broken, the flange 400 cannot be broken. Thus, the second opening/closing part 390 disposed on the flange 400 can be operated.

The second opening/closing part 390 may be provided in plural.

Even though one second pipe part 290 is connected to the flange 400 in FIG. 3, a plurality of second pipe parts 290 may be connected to the flange 400.

The sensor part senses a loss-of-coolant accident, and may include various sensors.

That is, the sensor part may function as a pressure sensor for sensing pressure of coolant within the nuclear reactor vessel 100, or as a level sensor for sensing a level of the coolant.

In addition, the sensor part may function as a temperature sensor for sensing temperature of the coolant within the nuclear reactor vessel 100, or as a radioactivity measuring sensor for measuring an amount of radioactivity.

When the sensor part senses a loss-of-coolant accident, the control part controls the first opening/closing part 300 or the second opening/closing part 390 to be closed, thereby preventing coolant from being discharged through a broken line of the first pipe part 200 or the second pipe part 290.

At this point, an internal pressure difference occurs between the nuclear reactor vessel 100 and the supplementary coolant injection part 500, thereby injecting the supplementary coolant from the supplementary coolant injection part 500 into the nuclear reactor vessel 100 through the check valve 600.

A main power source is connected to the nuclear reactor in normal operations, and supplies power for opening and closing the first opening/closing part 300 or the second opening/closing part 390, thereby supplying or draining fluid.

Even in the case that the first pipe part 200 is broken, unless the main power source is disconnected, the main power source continually supplies power. However, when the first pipe part 200 is broken and the main power source is disconnected, an auxiliary power source 800 may supply power for opening and closing the first opening/closing part 300.

Also when the second pipe part 290 is broken and the main power source is disconnected, the auxiliary power source 800 may supply power for opening and closing the second opening/closing part 390.

The auxiliary power source 800 may include a diesel electricity generator and/or a battery.

When a loss-of-coolant accident occurs, an amount of coolant may be insufficient within the nuclear reactor, and thus, the reactor core 900 may be melted. To prevent such melting of the reactor core 900 within the nuclear reactor, residual heat should be removed from the reactor core 900.

To this end, the nuclear reactor may include a passive residual heat removal system 700, connected to the steam generators 150 disposed within the nuclear reactor vessel 100.

As illustrated in FIG. 2, the passive residual heat removal system 700 includes a heat exchanger 710 disposed outside the nuclear reactor vessel 100 and connected to the steam generators 150 to circulate coolant, thereby removing residual heat from the reactor core 900.

That is, after the nuclear reactor is shutdown, when a secondary system cannot cool a reactor coolant system, the passive residual heat removal system 700 opens a valve 722 connected to the heat exchanger 710 as illustrated in FIG. 5.

In addition, a valve 724, connected to a turbine system to transfer steam from the steam generators 150 to the secondary system, and a valve 726, connected to a feed water system to supply water to the steam generators 150, are closed.

At this point, steam generated from the steam generators 150 is transferred to the heat exchanger 710 through a pipe, and is condensed through heat exchange, and water formed by condensing the steam is introduced into the steam generators 150. This cycle is repeated.

Accordingly, the passive residual heat removal system 700 uses the steam generators 150 to remove residual heat from the reactor core 900 and sensible heat from the reactor coolant system, thereby cooling the reactor coolant system from a normal operation condition to a safe shutdown condition having a temperature where a shutdown cooling system starts to operate.

Hereinafter, an operation of the nuclear reactor adapted for mitigating a loss-of-coolant accident will be described.

Referring to FIGS. 2 and 3, the nuclear reactor vessel 100 is connected to the first pipe parts 200 to supply or drain fluid. The nuclear reactor vessel 100 may be connected to the first pipe parts 200 through the flange 400 to reinforce the connected portion therebetween.

The first opening/closing parts 300, which may include valves, may be disposed on the flange 400.

Even in the case that the first pipe part 200 is broken by internal pressure or external force, the flange 400 as a reinforcement cannot be broken, so that the first opening/closing parts 300 disposed on the flange 400 can be operated.

The sensor part including various sensors may be disposed on the nuclear reactor. When the sensor part senses a loss-of-coolant accident, the control part may receive a sensing signal from the sensor part and control the first opening/closing parts 300 to be closed.

Accordingly, when a loss-of-coolant accident occurs, the first pipe part 200 can be closed, and the loss-of-coolant accident can be mitigated.

After the first opening/closing part 300 is closed to mitigate the loss-of-coolant accident, supplementary coolant may be injected into the nuclear reactor vessel 100 through the supplementary coolant injection part 500 connected to the nuclear reactor vessel 100.

The first opening/closing part 300 is operated using power supplied from the main power source. When the main power source is disconnected during the loss-of-coolant accident, the auxiliary power source may supply power.

The second pipe part 290 may be broken by internal pressure or external force. At this point, the flange 400 as a reinforcement connected to the second pipe part 290 cannot be broken, so that the second opening/closing parts 390 disposed on the flange 400 can be operated.

Accordingly, when the loss-of-coolant accident occurs, the second pipe part 290 can be closed, and the loss-of-coolant accident can be mitigated.

The order of describing the operation of the nuclear reactor does not limit the order of the operation thereof, and thus, may be changed.

Hereinafter, an operation of the nuclear reactor when the first pipe part 200 is broken will now be described.

An operation of the nuclear reactor when the second pipe part 290 is broken may be similar to the operation of the nuclear reactor when the first pipe part 200 is broken.

Referring to FIG. 2, the inflow members 310 disposed on the inflow pipe 210, and the outflow members 320 disposed on the outflow pipe 220 are opened in the normal state.

In this state, if necessary, fluid may be supplied into or drained from the nuclear reactor vessel 100 through the inflow pipe 210 or the outflow pipe 220, as described above.

At this point, the check valve 600 connected to the supplementary coolant injection part 500 is closed, and the valve 722 connected to the heat exchanger 710 of the passive residual heat removal system 700 is also closed.

However, since the valve 724 connected to the turbine system is opened, steam generated from the steam generators 150 is transferred through a pipe to drive a turbine.

Also, the valve 726 connected to the feed water system is opened to supply water from the feed water system to the steam generators 150.

Referring to FIGS. 4 and 5, a portion of the first pipe part 200 may be broken by an accident. At this point, the first opening/closing part 300 closes the broken line of the first pipe part 200 in early stage, thereby mitigating a loss-of-coolant accident.

At this point, the check valve 600 connected to the supplementary coolant injection part 500 is opened to inject supplementary coolant from the supplementary coolant injection part 500 into the nuclear reactor vessel 100.

Meanwhile, the valve 724 connected to the turbine system and the valve 726 connected to the feed water system are closed to prevent coolant from flowing between the steam generators 150 and the secondary system.

At this point, the valve 722 connected to the heat exchanger 710 is opened, and steam generated from the steam generators 150 is transferred to the heat exchanger 710 through a pipe, and is then condensed through heat exchange, and water formed by condensing the steam is introduced into the steam generators 150. This cycle is repeated.

Hereinafter, a method of mitigating a loss-of-coolant accident will now be described according to an embodiment of the present invention.

First, when the sensor part including various sensors senses a loss-of-coolant accident, the sensor part transmits a sensing signal to the control part.

The control part receives the sensing signal from the sensor part to close the first opening/closing part 300 or the second opening/closing part 390 by using power supplied from the main power source or the auxiliary power source 800. Accordingly, a broken line of the first pipe part 200 or the second pipe part 290 is closed.

Thus, the loss-of-coolant accident is mitigated.

After the first pipe part 200 is closed, supplementary coolant is injected into the nuclear reactor vessel 100 from the supplementary coolant injection part 500 through the check valve 600.

Alternatively, after the second pipe part 290, which is connected to one of the supplementary coolant injection parts 500, is broken and closed, supplementary coolant is injected into the nuclear reactor vessel 100 from another one of the supplementary coolant injection parts 500.

Next, the passive residual heat removal system 700 uses the steam generators 150 to remove residual heat from the reactor core 900 and sensible heat from the reactor coolant system, thereby cooling the reactor coolant system from the normal operation condition to the safe shutdown condition having the temperature where the shutdown cooling system starts to operate.

According to the embodiments of the present invention, when a first pipe part connected to a nuclear reactor is broken, a first opening/closing part quickly closes a broken line of the first pipe part, thereby stopping discharge of coolant.

In addition, since loss of coolant is stopped as described above, safety features required to operate for an extended period of time, such as a safety injection system or a safe guard vessel, are unnecessary, thereby decreasing construction costs and improving economical efficiency.

In addition, since the first opening/closing part quickly closes the broken line of the first pipe part, an amount of coolant lost can be decreased, and it decreases a design pressure of a nuclear reactor building (a containment vessel), thus decrease construction costs thereof and increase economical efficiency.

In addition, a flange connects the first pipe part or a second pipe part to a nuclear reactor vessel to reinforce a connected portion therebetween. Thus, even in the case that the first pipe part or the second pipe part is broken, the first opening/closing part or a second opening/closing part closes a broken line of the first pipe part or the second pipe part.

In addition, when the first pipe part is broken, a high concentration boric acid solution can be added through a supplementary coolant injection part in order to compensate for the loss of coolant.

In addition, when a main power source is disconnected, the first opening/closing part can be operated using an auxiliary power source including a diesel electricity generator and/or a battery.

While the present invention has been shown and described in connection with the exemplary embodiments, it will be apparent to those skilled in the art that modifications and variations can be made without departing from the spirit and scope of the invention as defined by the appended claims.

What is claimed is:

1. A nuclear reactor adapted for mitigating a loss-of-coolant accident, comprising:
a nuclear reactor vessel:
a first pipe part connected to the nuclear reactor vessel to supply or drain fluid; and
a first opening/closing part connected to the first pipe part,
wherein when the first pipe part is broken, the first opening/closing part closes the first pipe part to stop discharge of coolant.

2. The nuclear reactor of claim 1, wherein the nuclear reactor vessel is connected to the first pipe part through a flange to reinforce a connected portion therebetween, and
the first opening/closing part is disposed on the flange.

3. The nuclear reactor of claim 1, further comprising a supplementary coolant injection part that is connected to the nuclear reactor vessel to compensate for the loss of coolant through a broken line of the first pipe part.

4. The nuclear reactor of claim 3, wherein the supplementary coolant injection part is connected to the nuclear reactor vessel through a second pipe part, and
a second opening/closing part is connected to the second pipe part to close the second pipe part to stop discharge of coolant when the second pipe part is broken.

5. The nuclear reactor of claim 4, wherein the nuclear reactor vessel is connected to the second pipe part through a flange to reinforce a connected portion therebetween, and
the second opening/closing part is disposed on the flange.

6. The nuclear reactor of claim 1, further comprising:
a sensor part sensing a loss-of-coolant accident; and
a control part controlling opening and closing of the first opening/closing part when the sensor part senses a loss-of-coolant accident.

7. The nuclear reactor of claim 2, further comprising:
a sensor part sensing a loss-of-coolant accident; and
a control part controlling opening and closing of the first opening/closing part when the sensor part senses a loss-of-coolant accident.

8. The nuclear reactor of claim 4, further comprising:
a sensor part sensing a loss-of-coolant accident; and
a control part controlling opening and closing of the second opening/closing part when the sensor part senses a loss-of-coolant accident.

9. The nuclear reactor of claim 5, further comprising:
a sensor part sensing a loss-of-coolant accident; and
a control part controlling opening and closing of the second opening/closing part when the sensor part senses a loss-of-coolant accident.

10. The nuclear reactor of claim 1, further comprising an auxiliary power source that supplies power for opening and closing the first opening/closing part when a main power source is disconnected during a loss-of-coolant accident.

11. The nuclear reactor of claim 2, further comprising an auxiliary power source that supplies power for opening and closing the first opening/closing part when a main power source is disconnected during a loss-of-coolant accident.

12. The nuclear reactor of claim 4, further comprising an auxiliary power source that supplies power for opening and closing the second opening/closing part when a main power source is disconnected during a loss-of-coolant accident.

13. The nuclear reactor of claim 5, further comprising an auxiliary power source that supplies power for opening and closing the second opening/closing part when a main power source is disconnected during a loss-of-coolant accident.

14. A method of mitigating a loss-of-coolant accident in a nuclear reactor, comprising:
sensing a loss-of-coolant accident by a sensor part; and
operating, by a control part when a loss-of-coolant accident is sensed, a first opening/closing part to close a first pipe part connected to a side of a nuclear reactor vessel.

15. The method of claim 14, further comprising injecting supplementary coolant from a supplementary coolant injection part into the nuclear reactor vessel when coolant is partially lost.
